(19) United States
(12) Patent Application Publication
(10) Pub. No.: US 2014/0039753 A1
(43) Pub. Date: Feb. 6, 2014

(54) METHOD AND SYSTEM FOR THE DETERMINATION OF A STEERING ANGLE

(71) Applicants: Erik Smits, Dutton Park (AU); Matthew Fraser, Dutton Park (AU)

(72) Inventors: Erik Smits, Dutton Park (AU); Matthew Fraser, Dutton Park (AU)

(73) Assignee: LEICA GEOSYSTEMS AG, Heerbrugg (CH)

(21) Appl. No.: 13/996,473

(22) PCT Filed: Nov. 28, 2011
(86) PCT No.: PCT/AU2011/001545

§ 371 Date: Sep. 24, 2013

(30) Foreign Application Priority Data
Dec. 23, 2010 (AU) 2010905615

(51) Int. Cl. B62D 5/06

(52) U.S. Cl. CPC B62D 5/06
USPC 701/34.4

(57) ABSTRACT

A method and system are provided for determining the angle of steering of a vehicle, particularly an agricultural vehicle, by determining vehicle yaw rate, determining vehicle speed, determining hydraulic flow in a hydraulic steering assembly connected in parallel with a manual hydraulic steering circuit of the vehicle, and processing the yaw rate, speed, and hydraulic flow data to determine the angle of steering of the vehicle.

### FIELD OF THE INVENTION

The invention relates to the determination of the angle of steering of a vehicle. In particular, the invention relates to determination of the angle of steering of a vehicle having a hydraulically actuated steering system, the angle being determined utilising a combination of at least measured yaw rate, speed, and hydraulic flow.

### BACKGROUND TO THE INVENTION

Automated guidance systems are sometimes used to guide and/or steer vehicles, particularly vehicles that are operated in off-road environments such as in agricultural, construction, mining, and forestry applications; such as tractors, harvesters, diggers, graders, dump trucks, and other powered vehicles. Typically the guidance system is designed to assist an operator in guiding the vehicle along a predetermined route, either by providing guidance to an operator of the vehicle or by actually operating the vehicle in an autonomous (or semi-autonomous) manner.

The guidance systems typically include a Global Navigation Satellite System (GNSS) unit (e.g., utilising real time kinematic (RTK), GPS, etc.) to determine, and in many cases display, the location of the vehicle compared to a predetermined area and/or route. These guidance systems typically store the predetermined route on board, compare the known location of the vehicle with that route, and use this information to control the output (e.g., to provide guidance or to partially or fully operate the vehicle).

For autonomous (or semi-autonomous) operation, it is necessary for the guidance system to steer the vehicle. However, for the guidance system to effectively steer the vehicle, it is necessary to know the current angle of steering (e.g., by measurement or estimation). Known methods to determine the angle of the vehicle wheels utilise mechanical angle measurement, gyroscopic and GNSS measurements, or hydraulic flow sensors in the hydraulic steering circuit.

Mechanical angle is typically measured by having a sensor that directly measures the angle of the vehicle wheels, e.g. by utilising a potentiometer or rotary encoder, or the like. Gyroscopic and GNSS measurements use a gyroscope to measure yaw rate and a GNSS to measure speed to estimate the angle of steering. Finally, hydraulic flow sensors in the vehicle steering circuit integrate the flow of hydraulic fluids to the steering ram to estimate the angle of the vehicle wheels.

For automated hydraulic steering kits, and to a lesser extent for installation of automated hydraulic steering during manufacture, the ease of fitting and accuracy of the system are of critical importance. Of the abovementioned known measurement systems, the ease of fitting from best to worst is: gyroscopic and GNSS systems, hydraulic flow sensing systems, and then mechanical angle measurement systems. In contrast, the accuracy from best to worst is: mechanical angle measurement systems, hydraulic flow sensing systems, and then gyroscopic and GNSS systems. This is summarised in the following table:

| System: | Accuracy: | Ease of fitting: |
|---|---|---|
| Mechanical angle | Best | Worst |
| Hydraulic flow | Middle | Middle |
| Yaw rate/speed | Worst | Best |

Apparent from the above, the ease of fitting and the accuracy of the systems are generally inversely proportionate (i.e., the most accurate is the hardest to fit and the easiest to fit is the least accurate).

Hydraulic flow systems, which were placed in the middle for both accuracy and ease of fitting, may seem like an appropriate balance between the accuracy and ease of fitting parameters. However, hydraulic flow systems also suffer from a safety drawback. In this regard, if a hydraulic flow sensor fails in a blocked state the steering of the vehicle is compromised by the lack of hydraulic fluid flow in the steering circuit. This affects both automated and manual steering as the flow sensor is fitted in the actual steering circuit.

In order to reduce this considerable safety hazard, safety valves are fitted in parallel with any flow sensors to allow operator control of the steering of the vehicle even when the flow sensors are in such a fail state. However, even with safety valves in place the steering response is reduced when in a failed state. Although better than having no safety valves, the safety of the vehicle is still compromised to some degree by the reduced steering response which the operator may need to overcome.

### OBJECT OF THE INVENTION

It is an aim of this invention to provide a method and system for the determination of a steering angle of a vehicle wheel which overcomes or ameliorates one or more of the disadvantages or problems described above, or which at least provides a useful alternative.

### SUMMARY OF INVENTION

According to a first aspect of the invention, there is provided a method for determination of a steering angle of a vehicle, the method comprising the steps of:

determining vehicle yaw rate;

determining vehicle speed;

determining hydraulic flow in a hydraulic steering assembly connected in parallel with a manual hydraulic steering circuit of the vehicle; and

processing the yaw rate, speed, and hydraulic flow data to determine the angle of steering of the vehicle.

The processing step preferably comprises utilising the yaw rate and speed data to generate an absolute estimate (or refine a previous estimate) of the steering angle, and utilising the flow rate data to generate a relative estimate of the angle of steering.

The method is preferably initiated upon automatic steering of the vehicle being engaged. Preferably the automatic steering is engaged by an operator. Upon initiation of automatic steering, the steps of determining the yaw rate and speed of the vehicle are preferably carried out first, with the processing step preferably then utilising the initially determined yaw rate and speed data to generate an initial estimate of the steering angle.

Once the initial estimate of the steering angle of the vehicle wheel is determined, subsequent determinations of the yaw rate and speed of the vehicle are preferably processed to refine the estimate of the steering angle. The flow rate data may then be utilised to provide a relative estimate of steering angle changes from the hydraulic steering assembly (e.g., changes since the automatic steering was engaged).

The method may further comprise the step of determining the location of the vehicle relative to an area (e.g., a field, region, country, the world, etc.). The location is preferably determined utilising GNSS or RTK, or the like. The location of the vehicle relative to at least a portion of the area may be indicated on a display. Preferably the display located in a cab of the vehicle.

One or more of the determined variables, such as yaw rate, speed, and determined steering angle, may also be displayed. The method may further comprise the step of inputting a predetermined route. The predetermined route, or a portion thereof, may also be indicated on the display. Where a predetermined route is provided, the method preferably further comprises the step of tracking the location of the vehicle relative to the predetermined route and issuing control signals, regarding at least steering angle, in order to keep the vehicle on the predetermined route.

According to a second aspect of the invention, there is provided a method of determining the angle of a steering of a vehicle for use in an automated steering system, the method comprising the steps of:

engaging the automated steering system;

performing an initial steering angle estimate comprising:
determining vehicle yaw rate;
determining vehicle speed; and
processing the yaw rate and speed of the vehicle to generate an initial absolute estimate of the angle of steering;

thereafter, at least while the automated steering system is engaged, iteratively:
determining vehicle yaw rate;
determining vehicle speed;
determining hydraulic flow in a hydraulic steering assembly connected in parallel with a manual hydraulic steering circuit of the vehicle;
processing the yaw rate and speed data to refine the absolute estimate of the angle of steering;
processing hydraulic flow rate data to generate an estimate of the relative angle of steering changes since the automated steering system was engaged; and
determining the angle of steering of the vehicle using the absolute and relative estimates.

The step of determining the yaw rate of the vehicle preferably comprises measuring an output of a gyroscopic sensor. The gyroscopic sensor is preferably located on the body of the vehicle, even more preferably in a cab of the vehicle. The gyroscopic sensor (or a further gyroscopic sensor) may be located in at least one of the wheels of the vehicle (e.g., to assist in determining the yaw rate of the wheel, and hence the angle of a vehicle wheel).

The step of determining the speed of the vehicle preferably comprises calculating the speed of the vehicle from GNSS data. The speed of the vehicle may also be determined from vehicle instrumentation (e.g. the speedometer).

According to a third aspect of the invention, there is provided a steering system that determines the angle of steering of a vehicle, the steering system comprising:

a yaw rate determination unit;

a speed determination unit;

a steering control system; and

a hydraulic steering assembly connected in parallel with a manual hydraulic steering circuit of the vehicle, wherein the hydraulic steering assembly comprises:
a hydraulic valve block in communication with the steering control system to actuate hydraulic flow in hydraulic lines connected to the hydraulic steering circuit; and
a flow sensor in at least one of the hydraulic lines between the valve block and the hydraulic steering circuit;

wherein the steering control system processes data from the yaw rate determination unit, speed determination unit, and the flow sensor of the hydraulic steering assembly to determine the angle of steering of the vehicle.

Preferably, the steering control system estimates the angle of steering by processing the yaw rate from the yaw rate determination unit and speed from the speed determination unit to initially generate, or subsequently refine, an absolute estimate of the angle of steering, and processing measured flow rate from the flow sensor of the hydraulic steering assembly to generate a relative estimate of the angle of steering. Preferably the steering control system processes the absolute and relative estimates to determine the angle of the steering wheel.

The yaw rate determination unit preferably comprises a gyroscopic sensor. The gyroscopic sensor is preferably mounted on the body of the vehicle, even more preferably in a cab of the vehicle. The gyroscopic sensor (or a further gyroscopic sensor) may be located in at least one of the vehicle wheels (e.g., to assist in determining the yaw rate of the wheel).

Preferably, the steering system further comprises a GNSS sensor. The speed determination unit preferably utilises GNSS data from the GNSS sensor to calculate the speed of the vehicle.

The steering system may further comprise a console, preferably as part of the steering control system. The console preferably provides a user interface for an operator to interact and/or communicate with the system. The console preferably comprises a display. The console is preferably mounted in the cab of the vehicle (e.g., on the windscreen or in a standard radio DIN slot). The console preferably includes the GNSS sensor and communicates with one or more GNSS antennae which may be mounted externally to the cab.

The steering control system may further comprise a steering control unit. Preferably the steering control unit is selectively engaged. Preferably the steering control unit is selectively engaged by an operator. The steering control unit may be integral with the console, or as a separate device. Where the steering control unit is a separate device it is preferably located external to the cab and is electrically connected to the console via one or more cables. Alternatively (or additionally) the steering control unit may communicate with the console (and/or other components) wirelessly.

Preferably the steering system is an automated steering system and, in a preferred embodiment, there is preferably only flow in the hydraulic lines between the valve block and the hydraulic steering circuit when the automated steering system is engaged.

The valve block is preferably hydraulically connected: to the manual hydraulic steering circuit by two hydraulic lines, to a pressure line of a hydraulic pump of the vehicle by another hydraulic line, and to a hydraulic tank/reservoir of the vehicle by a further hydraulic line. When the steering control system is enabled, and actuating the valve block, the steering system preferably utilises the existing hydraulic pump and reservoir of the vehicle, via the valve block, to drive the steering circuit. The output from the steering control system may be determined by a plurality of factors, but preferably includes a consideration of the determined steering angle.

According to a fourth aspect of the invention, there is provided an automated steering kit for fitting to an existing vehicle, the kit comprising:

a yaw rate determination unit;

a speed determination unit;

a steering control system;

a hydraulic valve block in communication with the steering control system to actuate hydraulic flow in hydraulic lines connectable to a manual hydraulic steering circuit of the vehicle; and

a flow sensor in a hydraulic line between the valve block and the hydraulic steering circuit to measure hydraulic flow in the hydraulic line;

wherein the steering control system:
receives and processes data from the yaw rate determination unit, speed determination unit, and the flow sensor to determine the angle of steering of the vehicle; and
processes the determined angle of steering, together with other relevant data, to determine a steering control output to be actuated by the hydraulic valve block.

Preferably, the steering control system processes the yaw rate from the yaw rate determination unit and speed from the speed determination unit to generate or refine an absolute estimate of the angle of steering, processes measured flow rate from the flow sensor to generate a relative estimate of the angle of steering, and processes the absolute and relative estimates to determine the actual angle of steering.

### BRIEF DESCRIPTION OF THE DRAWINGS

By way of example only, preferred embodiments of the invention will be described more fully hereinafter with reference to the accompanying figures, wherein:

FIG. 1 is a diagrammatic view illustrating components and their connections according to an embodiment of the invention.

FIG. 2 is a flow chart broadly illustrating a method of determining the angle of steering utilising some of the components of FIG. 1.

FIG. 3 is a flow chart illustrating the method of determining the angle of steering shown in FIG. 2 in more detail according to an embodiment of the invention.

FIG. 4 is a flow chart broadly illustrating a method of operating an automatic steering system using the steering angle determination.

### DETAILED DESCRIPTION OF THE DRAWINGS

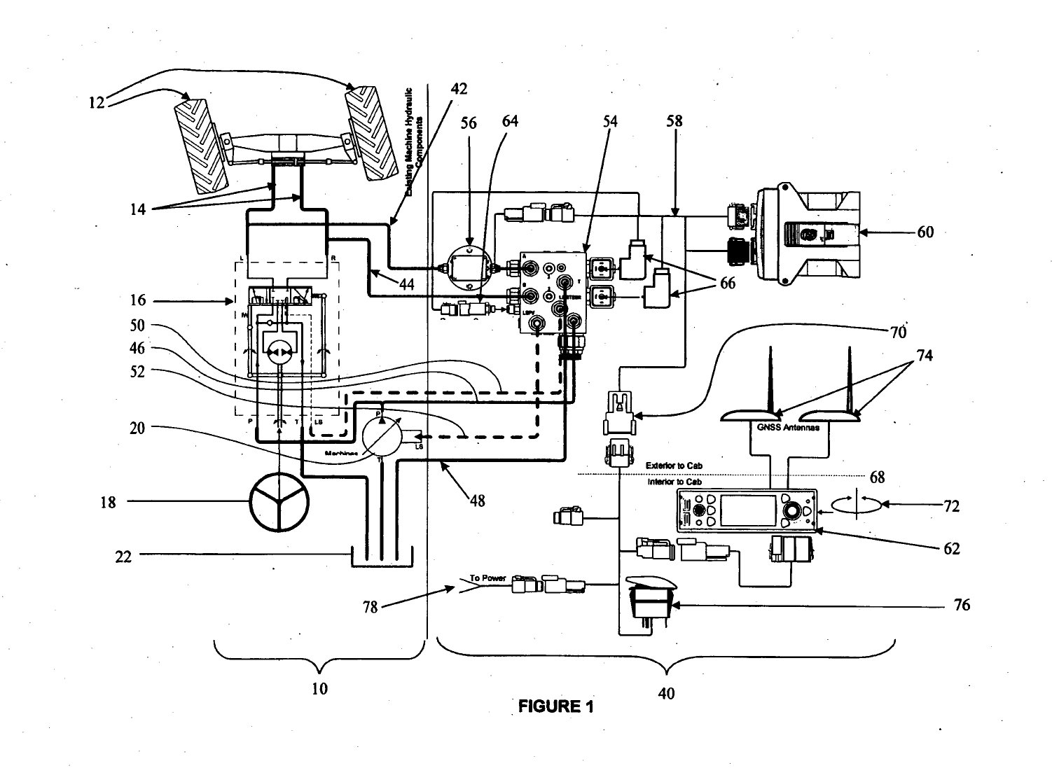

FIG. 1 shows a diagrammatic view having components of a vehicle 10 and components of an automated steering system 40. The vehicle 10 has wheels 12 which are steered by hydraulic lines connected to a standard hydraulic steering assembly 16. The hydraulic steering assembly 16, which typically includes hydraulic valves and an orbital motor, is controlled by a manual steer wheel 18 connected therewith. In use, as the manual steer wheel 18 is turned (typically by an operator) the hydraulic steering assembly 16 actuates the hydraulic fluid in the hydraulic lines 14 to steer the wheels 12 (i.e., turn the wheels left or right, changing their angle relative to the vehicle body).

The vehicle 10 also includes a hydraulic pump 20 connected between a reservoir 22 and the hydraulic steering assembly 16. The hydraulic pump 20 in the illustrated embodiment has a variable delivery rate and transfers hydraulic fluid from the reservoir 22 via a hydraulic hose connected to an input of the pump 20 labelled ‘T’ (for tank) to the hydraulic steering assembly 16 via a hydraulic hose connected to an output of the pump 20 labelled ‘P’ (for pressure). The illustrated pump 20 also has load sensing, labelled LS.

The automated steering system 40 is hydraulically connected to the vehicle 10 by hydraulic lines 42 and 44 connected to the existing steering lines 14 of the vehicle 10 by hydraulic line 46 connected to the pressure side of the hydraulic pump 20, and by hydraulic line 48 connected to the reservoir 22. Optionally, the steering system 40 may also be connected by hydraulic lines 50 and 52 for load sensing (from the steering assembly 16 and pump 20, respectively).

All of hydraulic lines 42, 44, 46, 48, 50, and 52 are hydraulically connected to a valve block 54. Hydraulic line 42 is connected via a flow sensor 56, for reasons which will become apparent. The valve block 54 is electrically connected, via electrical cables 58, to a steering control system in the form of a steering controller 60 and a guidance console 62. Although electrical cables 58 are utilised to physically connect various components, wireless communication may also be utilised in place of, or in addition to, at least some of the electrical cables. Furthermore, although the steering controller 60 and guidance console 62 are shown as separate components, it will be appreciated that they may also be integral.

The steering controller 60 is electrically connected to the valve block 54 by a pressure sensor 64, the flow sensor 56, and hydraulic actuator inputs 66. The steering controller 60 is, in the illustrated embodiment, external to the cab, as indicated by dashed line 68. The steering controller 60 and guidance console 62 are electrically connected via connector 70. Throughout FIG. 1 various connectors are shown. These are typically to keep the system modular, and to assist with isolating various parts or components, e.g., when servicing the system. A skilled person will recognise that they generally do not substantially affect the function of the invention (unless otherwise noted) and that they are primarily included for convenience.

The guidance console 62 includes a yaw rate determination unit in the form of an internal gyroscopic sensor (or ‘gyro’) indicated by 72, and a speed determination unit in the form of a GNSS system. The GNSS system has one or more GNSS sensors (typically in the guidance console 62) and is connected to one or more GNSS antennas 74 (two being illustrated in FIG. 1), which are typically mounted on the exterior of the cab to reduce signal losses and interference, and the like. With one or more readings of the position of the vehicle 10 over time via the GNSS system, the speed (and heading) of vehicle can be determined. Alternatively, the speed of the vehicle may be determined from instrumentation of the vehicle (e.g. by the speedometer) or from other suitable measurement techniques. The GNSS measurements may also be used to correct any bias in the gyroscopic sensor.

The guidance console 62 is also connected to an engage switch 76 and to a power source 78. The power source 78 is preferably taken direct from a power source of the vehicle, such as from the vehicle's battery (not shown). Alternatively (or even in addition) the steering system 40 may have its own power storage (e.g., battery) and/or generation (e.g., solar).

When the vehicle 10 is being operated under manual control the steering system 40 is typically inactive. The steering system 40 may be in a standby or generally passive state, or may be actively monitoring the location of the vehicle 10 using GNSS, and the like, without actually interfering with the steering of the vehicle 10 (e.g., providing feedback to the operator but not providing any control to the vehicle).

In use, steering controller 60 and/or guidance console 62 process GNSS data from received from the GNSS antennas 74 to determine, among other things (e.g., the location of the vehicle), the speed of the vehicle. Additionally, the steering controller 60 and/or guidance console 62 use the gyro 72 to determine the yaw rate of the vehicle 10. The flow sensor 56 can be utilised to determine hydraulic flow in hydraulic line 42 (as illustrated or, alternatively, in hydraulic line 44). It will be appreciated that flow in line 42 is the reverse of the flow in line 44 and as the flow sensor can sense flow in both directions, a single flow sensor in either of lines 42 or 44 should be all that is required to determine flow in both hydraulic lines (for at least for this type of steering mechanism). As hydraulic lines 42 and 44 are connected to the existing steering hydraulic lines 14 in parallel, the flow sensor 56 does not sense flow in the original hydraulic steering lines 14 when the vehicle is under manual control (i.e., when the vehicle is being steered by the operator via the manual steer wheel 18).

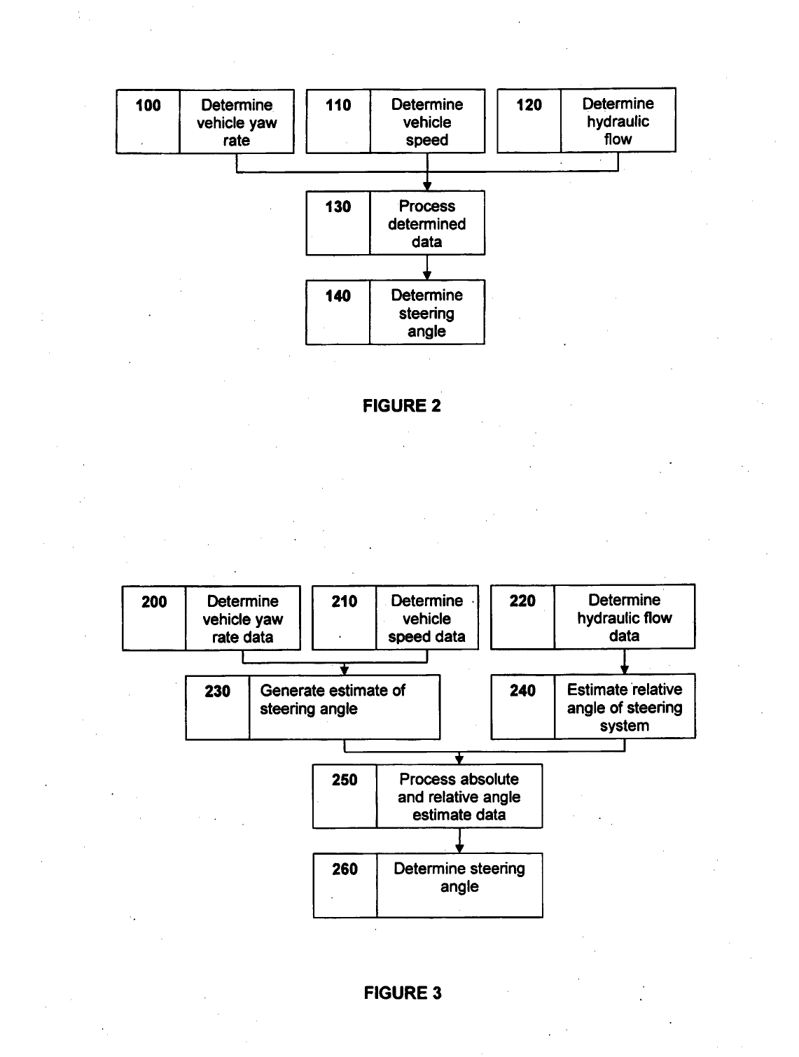

As shown in FIG. 2, when in use the vehicle steering system 40 determines vehicle yaw rate data (step 100), vehicle speed data (step 110), and hydraulic flow data (step 120). Although these steps (100, 110, and 120) as shown in parallel, it will be appreciated that one or more of the steps may also, be in series. The determined data (from steps 100, 110, and 120) is subsequently processed (step 130), by the steering controller 60 and/or guidance console 62, and the angle of the wheels 12 is determined (step 140). The determined steering angle of wheels 12 may then be utilised in control systems to assist in automatically operating the vehicle 10.

FIG. 3, which is much like FIG. 2, further shows that the vehicle yaw rate data (determined at step 200) and vehicle speed data (determined at step 210) are utilised in an embodiment to either initially generate an estimate of the absolute angle of the wheels 12, or to refine an existing estimate of the absolute angle of the wheels 12 (step 230). The hydraulic flow data (determined at step 220) is then utilised to estimate a relative angle (step 240).

The estimated relative angle (from step 240) relies upon direct measurement of hydraulic flow from flow sensor 56, but only provides a relative angle measurement as the flow sensor 56 is only able to determine changes in hydraulic flow, and not the absolute angle of the wheels 12. Furthermore, as the flow sensor 56 does not sense any flow when the vehicle 10 is under manual control (i.e. the wheels 12 are being driven solely by the steering assembly 16) the angle of the wheels when the steering system 40 is engaged is not known (from the flow sensor). The estimate of absolute steering angle (from step 230) and the estimate of relative steering angle since inception of the system (from step 240) are then processed in combination (at step 250) to determine a high accuracy estimate of the actual angle of the wheels 12 relative to the vehicle 10. As the absolute estimate of the steering angle is refined over time (step 230), coupled with any accurate estimate of any relative changes (step 240), the accuracy of the determined wheel angle is also increased.

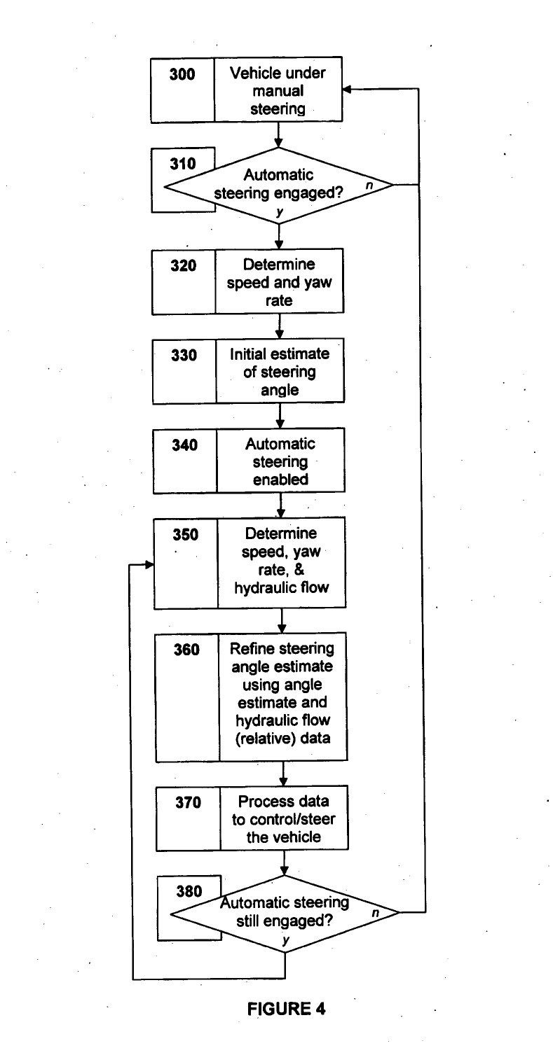

FIG. 4 shows a broad flow chart of an automatic steering system method. Initially, the vehicle is under manual steering (step 300), and stays in this state until automatic steering is engaged (at step 310). When the steering system 40 is engaged (at step 310), typically by the engage switch 76 being actuated by an operator, the yaw rate and speed of the vehicle is determined (step 320) and an initial estimate of the absolute steering angle is calculated (step 330). Once the initial estimate of steering angle has been calculated (step 330), the automatic steering system is enabled (step 340).

Once enabled (step 340), the speed, yaw rate, and flow rate are determined (step 350) to refine the steering angle estimate (step 360). In practice, the refining step (360) uses subsequent determinations of yaw rate and speed data to refine the absolute angle estimate and flow data from the flow sensor 56 to adjust for relative angle changes since the system was engaged (step 310).

The steering controller 60 then processes the steering angle data, together with other relevant data (e.g. speed, location, inclination, and the like), and outputs control signals to steer the vehicle (e.g., to keep the vehicle on a predetermined route) (step 370). The automatic steering system 40 continually refines the angle estimates (step 360) and controls the steering of the vehicle (step 370) until disabled (step 380). Once disabled, the vehicle reverts back to manual steering control (back to step 300).

With reference to FIG. 1, the steering system 40 is engaged by actuating the engage switch 76, at which stage the guidance console and/or steering controller process yaw rate data from the gyro 72 and speed determinable from the GNSS antennas 74 to generate an initial estimate of the absolute angle of the wheels 12. Once the initial estimate has been generated the steering controller 60 can start to issue control signals to actuate the valve block 54 (via electrical cable 58 and hydraulic actuator inputs 66). The valve block 54 routes hydraulic fluid as necessary to steer the wheels 12 of the vehicle 10 (e.g., by applying hydraulic pressure to line 42 or 44 in order to turn the wheels 12 to a desired angle).

By utilising yaw rate, speed, and hydraulic flow in the automatic steering circuit, the system is able to accurately determine the steering angle without having the associated difficulties of installing direct mechanical sensors.

Having the flow sensor 56 in parallel with added hydraulic lines 42, 44 means that the flow sensor 56 does not sense hydraulic flow when the vehicle is under manual control (i.e., no flow is sensed unless there is electro-hydraulic activation via the valve block 54). This results in the flow sensor 56 only being able to determine relative changes in steering while the steering system is engaged. However, by having the flow sensor in parallel with the main steering lines manual steering is unaffected in the event of a flow sensor failure (e.g., in a blocked state). This not only improves the safety of the system over typical hydraulic flow sensor only systems, but also does not require safety valves to be fitted in parallel around the flow sensor. Advantageously, the system provides substantially the same accuracy as previous flow metered systems, while providing easier installation, and increased reliability and safety.

The steering angle may be determined and utilised as the angle of a vehicle wheel relative to the body of a vehicle, as a curvature that the vehicle is travelling along, and the like. It will be appreciated that the steering angle determination may be applied to various types of vehicles including, for example, Ackermann style (as illustrated in FIG. 1), rear wheel steer, articulated, skid steer, and the like.

It is to be understood that the terminology employed above is for the purpose of description and, unless explicitly stated otherwise, should not be regarded as limiting.

As would be appreciated by a skilled person, the components of the vehicle 10 are typically all provided by an existing vehicle and, accordingly, there may be variations between the types and configurations of these components between different vehicles and manufacturers (and the like). As would be apparent to the skilled person the underlying principals and spirit of the invention should still apply, even if minor modifications or adaptations are required.

Use of the terms ‘determine’ and ‘estimate’ are not to be given a strict interpretation and, in fact, could be used interchangeably (that is, a determination may be an estimate, and an estimate may be a determination).

Where the context permits, reference to an integer or a component or step (or the like) is not to be interpreted as being limited to only one of that integer, component, or step, but rather could be one or more of that integer, component, or step etc.

In this specification, the terms ‘comprises’, ‘comprising’, ‘includes’, ‘including’, or similar terms are intended to mean a non-exclusive inclusion, such that a method, system or apparatus that comprises a list of elements does not include those elements solely, but may well include other elements not listed.

1. A method for determination of the angle of a steering of a vehicle, the method comprising the steps of:
determining vehicle yaw rate;
determining vehicle speed;
determining hydraulic flow in a hydraulic steering assembly connected in parallel with a manual hydraulic steering circuit of the vehicle; and
processing the yaw rate, speed, and hydraulic flow data to determine the angle of steering of the vehicle.

2. The method of claim 1, wherein the processing step comprises utilising the yaw rate and speed data to generate an absolute estimate of the steering angle.

3. The method of claim 1, wherein the processing step comprises utilising the hydraulic flow data to generate a relative estimate of the angle of steering.

4. The method of claim 1, further comprising the step of generating an initial estimate of the steering angle using determined yaw rate and speed of the vehicle.

5. A method of determining the angle of steering of a vehicle for use in an automated steering system, the method comprising the steps of:
engaging the automated steering system;
performing an initial steering angle estimate comprising:
determining vehicle yaw rate;
determining vehicle speed; and
processing the yaw rate and speed of the vehicle to generate an initial absolute estimate of the angle of steering;
thereafter, iteratively:
determining vehicle yaw rate;
determining vehicle speed;
determining hydraulic flow in a hydraulic steering assembly connected in parallel with a manual hydraulic steering circuit of the vehicle;
processing the yaw rate and speed data to refine the absolute estimate of the angle of steering;
processing hydraulic flow rate data to generate a relative estimate of the angle of steering since the automated steering system was engaged; and
determining the angle of steering of the vehicle using the absolute and relative estimates.

6. The method of claim 5, further comprising the step of determining the location of the vehicle relative to an area.

7. The method of claim 6, further comprising the step of tracking the location of the vehicle relative to a predetermined route.

8. The method of claim 7, further comprising the step of issuing control signals in relation to the steering angle in order to keep the vehicle on the predetermined route.

9. The method of claim 1, wherein the step of determining the yaw rate of the vehicle comprises measuring an output of a gyroscopic sensor.

10. The method of claim 1, wherein the step of determining the speed of the vehicle comprises calculating the speed of the vehicle from Global Navigation Satellite System (GNSS) data.

11. The method of claim 1, wherein the step of determining hydraulic flow in a hydraulic steering assembly comprises using a flow sensor in a hydraulic line between a valve block of the hydraulic steering assembly connected in parallel with a manual hydraulic steering circuit of the vehicle and the hydraulic steering circuit.

12. A steering system that determines the angle of steering of a vehicle, the steering system comprising:
a yaw rate determination unit;
a speed determination unit;
a steering control system; and
a hydraulic steering assembly connected in parallel with a manual hydraulic steering circuit of the vehicle, wherein the hydraulic steering assembly comprises:
a hydraulic valve block in communication with the steering control system to actuate hydraulic flow in hydraulic lines connected to the hydraulic steering circuit; and
a flow sensor in at least one of the hydraulic lines between the valve block and the hydraulic steering circuit;
wherein the steering control system processes data from the yaw rate determination unit, speed determination unit, and the flow sensor of the hydraulic steering assembly to determine the angle of steering.

13. The system of claim 12, wherein the steering control system estimates the angle of steering by processing yaw rate from the yaw rate determination unit speed from the speed determination unit to generate an absolute estimate of the angle of steering, and processing measured flow rate from the flow sensor of the hydraulic steering assembly to generate a relative estimate of the angle of steering.

14. The system of claim 12, wherein the yaw rate determination unit comprises a gyroscopic sensor.

15. The system of claim 12 wherein the speed determination unit utilises Global Navigation Satellite System (GNSS) data from a Global Navigation Satellite System (GNSS) sensor.

16. The system of claim 12, further comprising a steering control unit that is selectively engaged.

17. The system of claim 16, wherein the steering control unit is utilised to keep the vehicle on a predetermined route.

18. The system of claim 16, wherein the steering control unit actuates hydraulic flow in hydraulic lines connected to the manual hydraulic steering circuit of the vehicle.

19. The system of claim 18, wherein there is only flow in the hydraulic lines between the valve block and the hydraulic steering circuit when the steering control unit is engaged.

20. The system of claim 16, wherein the steering control unit utilises an existing hydraulic pump and reservoir of the manual hydraulic steering circuit of the vehicle when the steering control unit is engaged.

21. An automated steering kit for fitting to a vehicle, the kit comprising:
a yaw rate determination unit;
a speed determination unit;
a steering control system;
a hydraulic valve block in communication with the steering control system to actuate hydraulic flow in hydraulic lines connectable to a manual hydraulic steering circuit of the vehicle; and
a flow sensor in a hydraulic line between the valve block and the hydraulic steering circuit to measure hydraulic flow in the hydraulic line;
wherein the steering control system:
receives and processes data from the yaw rate determination unit, speed determination unit, and the flow sensor to determine the angle of steering; and
processes the determined angle of steering to determine a steering control output to be actuated by the hydraulic valve block.

22. The automated steering kit of claim 20, wherein the steering control system processes the yaw rate from the yaw rate determination unit and speed from the speed determination unit to generate or refine an absolute estimate of the angle of steering, processes measured flow rate from the flow sensor to generate a relative estimate of the angle of steering, and processes the absolute and relative estimates to determine the angle of steering of the vehicle.
